(19) United States
(12) Patent Application Publication
(10) Pub. No.: US 2005/0092876 A1
(43) Pub. Date: May 5, 2005

(54) Configurable accessory mounting arm

(76) Inventor: Jeffrey D. Carnevali, Seattle, WA (US)

Correspondence Address: Charles J. Rupnick, PO Box 46752, Seattle, WA, 98146, US

(21) Appl. No.: 10/883,258

(22) Filed: Jun. 30, 2004

Related U.S. Application Data
(63) Continuation-in-part of application No. 10/698,158, filed on Oct. 31, 2003.

(51) Int. Cl. F16M 13/00

(52) U.S. Cl. 248/160

(57) ABSTRACT

A handlebar-mountable accessory mounting arm apparatus having a mounting bracket formed of a substantially rigid elongated body formed partway therethrough with an optional arcuate groove having a longitudinal axis that is oriented crosswise of the elongated body, and a pair of fastener clearance passages formed through the body straddling the groove and oriented crosswise of both the longitudinal axis of the groove and a longitudinal axis of the elongated body; and a permanently bendable solid metal support arm having first and second end portions at opposite ends thereof, the first end portion being fixedly coupled to one end of the elongated body of the mounting bracket and oriented substantially in alignment with the longitudinal axis of the body. Optionally, two or more of the accessory mounting arm apparatus are combined in a stacked accessory mounting arm system

### FIELD OF THE INVENTION

The present invention relates to a configurable mounting bracket, and in particular to a vehicle-mountable multiply configurable mounting bracket structured for clamping to a handlebar of a bicycle, motorcycle, all terrain vehicle or the like.

### BACKGROUND OF THE INVENTION

Mounting brackets structured for clamping to a handlebar of a bicycle, motorcycle, all terrain vehicle or the like are generally well-known. Some of these known handlebar-mountable brackets are configurable to provide mounting apparatus at different positions relative to the vehicle handlebar. However, these known handlebar-mountable brackets have various limitations on their usefulness.

### SUMMARY OF THE INVENTION

The present invention is a handlebar-mountable accessory mounting arm apparatus that overcomes limitations of the prior art for mounting instruments and other devices on a vehicle handlebar or another suitable portion of a vehicle.

The handlebar accessory mounting arm apparatus of the invention is provided by a bracket formed of a substantially rigid elongated body having an optional arcuate groove formed in one longitudinal surface thereof and oriented crosswise to a longitudinal axis of the elongated body. A pair of elongated passages is formed through the body straddling the groove. A support arm is formed of a permanently bendable elongated metal rod having first and second substantially straight lengthwise end portions at opposite ends thereof, the first end portion is substantially aligned with the longitudinal axis of the body and fixedly coupled to one of the opposing end faces thereof.

According to one aspect of the invention, a discrete part-spherical ball mount formed of a resiliently deformable material with a substantially smooth outer surface is threadedly secured to the body. By example and without limitation, the body is formed with a passage therethrough between the arcuate groove and a surface of the body opposite from the groove. The discrete part-spherical ball mount has a threaded bore formed therein; and a threaded fastener resides in the passage formed through the body between the arcuate groove and a surface of the body opposite from the groove, the threaded fastener is threadedly engaged with the threaded bore formed in the discrete part-spherical ball mount. Alternatively, a discrete frame is interposed between the discrete part-spherical ball mount and the body. According to one example, the discrete part-spherical ball mount is threadedly coupled to the discrete frame.

According to different aspects of the invention, two, three or more of the handlebar accessory mounting arm apparatus of the invention are combined in a “stacked” system. At least one of the handlebar accessory mounting arm apparatus of the system includes the permanently bendable elongated support arm fixedly coupled to one of the opposing end faces of its rigid elongated body. Optionally, two or more of the handlebar accessory mounting arm apparatus of the system includes at least one of the permanently bendable elongated support arms.

According to another aspect of the invention, one of the stacked handlebar accessory mounting arm apparatus of the invention includes a part-spherical ball mount formed of a resiliently deformable material with a substantially smooth outer surface is fixedly coupled to one of the opposing end faces of its rigid elongated body.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a front pictorial view that illustrates the invention embodied as a vehicle handlebar accessory mounting arm apparatus having a rigid multiply configurable mounting bracket for securely and fixedly positioning a permanently bendable support arm for mounting useful accessories;

FIG. 2 is a rear pictorial view of the mounting bracket portion of the vehicle handlebar accessory mounting arm apparatus illustrated in FIG. 1;

FIG. 3 is a partially exploded front pictorial view that illustrates assembly of the handlebar accessory mounting arm apparatus of the invention;

FIG. 3A illustrates configurable mounting portion of the vehicle handlebar accessory mounting arm apparatus according to another embodiment of the invention having bolt clearance apertures embodied as round bolt clearance holes and the elongated bracket body being sufficiently long to permit the ball mount to be mounted outside the pattern of the apertures, rather than having the apertures straddling the ball mount as in other embodiments, and also illustrates the elongated bracket body being structured without the optional arcuate handlebar cutout or groove being formed therein as in other embodiments;

FIG. 4 is a front pictorial view that illustrates one alternative embodiment of the invention having an alternative discrete part-spherical ball mount;

FIG. 5 is a cross-sectional view that illustrates one alternative embodiment of a flanged ball mount having the discrete ball mount mounted to a discrete frame;

FIG. 6 is a pictorial view that illustrates another alternative embodiment of the flanged ball mount formed on a different discrete frame;

FIG. 7 illustrates another alternative embodiment of the invention having the support arm mated directly to the bracket body;

FIG. 8 is a front pictorial view that illustrates another alternative embodiment of the invention having the support arm formed integrally with the bracket body;

FIG. 9 is a detailed view of one multiply positionable mounting platform of the invention mounted a second end of the support arm opposite from the mounting bracket;

FIG. 10 illustrates one alternative embodiment of the mounting platform having a part-spherical ball mount;

FIG. 11 illustrates the mounting platform according to another embodiment of the invention having a partial geodesic sphere;

FIG. 12 illustrates the mounting platform according to yet another embodiment of the invention having a flanged mounting platform;

FIG. 13 illustrates one handlebar accessory mounting arm system of the invention that combines a pair of the handlebar accessory mounting arm apparatus of the invention into a system;

FIG. 14 is an exploded assembly view of the handlebar accessory mounting arm system illustrated in FIG. 13;

FIG. 15 illustrates another handlebar accessory mounting arm system that combines a different pair of the handlebar accessory mounting arm apparatus of the invention;

FIG. 16 is an exploded assembly view of the handlebar accessory mounting arm system illustrated in FIG. 15;

FIG. 17 illustrates still another handlebar accessory mounting arm system that combines three of the handlebar accessory mounting arm apparatus of the invention;

FIG. 18 is an exploded assembly view of the handlebar accessory mounting arm system illustrated in FIG. 17; and

FIG. 19 illustrates the triple handlebar accessory mounting arm system of FIG. 17 with a pair of threaded fasteners securing the three assemblies into the single system and further securing the system to a vehicle handlebar.

### DETAILED DESCRIPTION OF PREFERRED EMBODIMENT

In the Figures, like numerals indicate like elements.

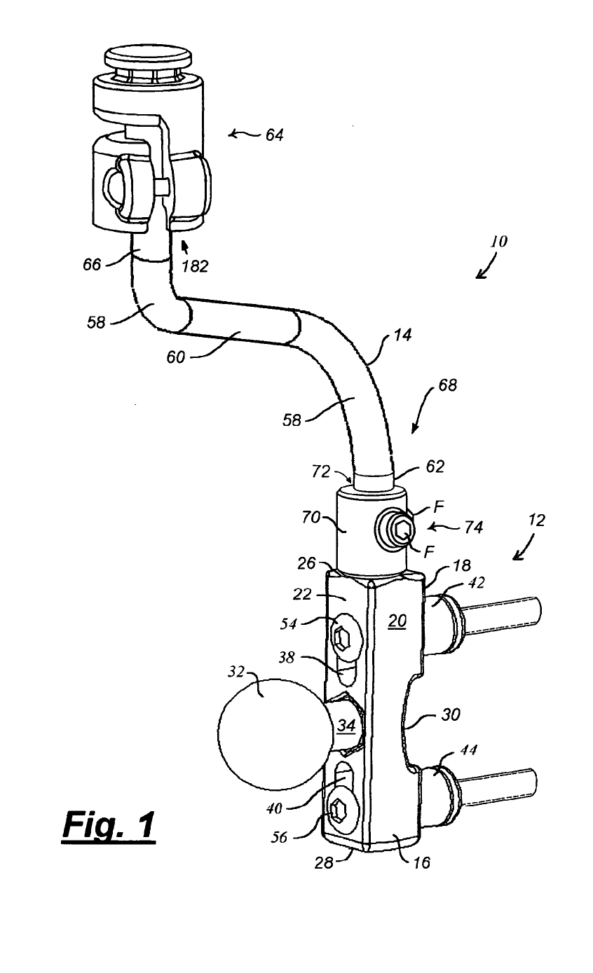

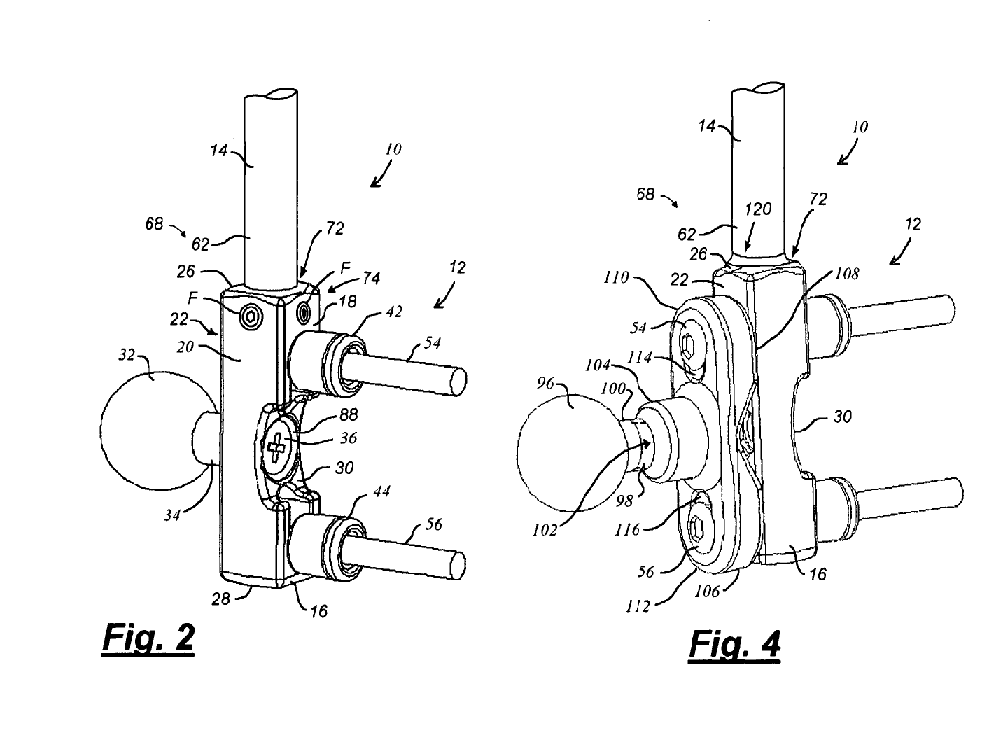

FIG. 1 is a front pictorial view and FIG. 2 is a rear pictorial view that together illustrate the invention embodied, by example and without limitation, as a vehicle handlebar accessory mounting arm apparatus 10 having a rigid multiply configurable mounting bracket 12 for securely and fixedly positioning a permanently bendable support arm 14 for mounting useful accessories within easy reach of the vehicle rider. The handlebar mounting arm apparatus 10 is formed at its core by the multiply configurable mounting bracket 12 of the type disclosed in co-pending U.S. patent application Ser. No. 10/862,688 entitled, “CONFIGURABLE MOUNTING BRACKET,” filed in the name of Jeffrey D. Camevali on Jun. 7, 2004, the complete disclosure of which is incorporated herein by reference. Accordingly, the mounting bracket 12 is embodied as a substantially rigid body 16 having an elongated substantially rectangular form structured with four orthogonal sides or faces 18, 20, 22 and 24 (opposite face 20) that are squared-off at opposite ends 26, 28. The edges and comers of the intersecting faces 18, 20, 22, 24 and ends 26, 28 are optionally broken, either by chamfers or rounds, to smooth the overall effect. Alternatively, the body 16 is cylindrical or another shape, and the ends 26, 28 are alternatively rounded, pointed, or another shape. The elongated rigid body 16 is optionally formed of hard plastic, aluminum, steel or another substantially rigid metallic or non-metallic material. An optional arcuate handlebar cutout or groove 30 is formed at or near the middle of one side or “handlebar mounting face” 18 thereof and is oriented crosswise of the elongated body 16. The arcuate structure renders the handlebar groove 30 suitable for either engaging a round or otherwise curved bar, such as a handlebar, or a for clearing a pre-existing instrument.

A discrete non-integral part-spherical ball mount 32 is formed of a resiliently deformable elastomeric material with a substantially smooth outer surface, as described by Carnevali in U.S. Pat. No. 5,845,885, the complete disclosure of which is incorporated herein by reference. The part-spherical ball mount 32 is provided, by example and without limitation, on a short substantially rigid internally-threaded stem 34 that is structured to be fastened to the mounting bracket body 16 to project from the face 22 opposite from the arcuate handlebar groove 30, when present, that is formed in the mounting face 18. The stem 34 is secured to the body face 22 in a manner that resists rotation of the ball mount 32 relative to the elongated bracket body 16. For example, the ball mount 32 is secured to the body face 22 means of a threaded fastener or screw 36 through the bracket body 16, as discussed in detail herein.

A pair of apertures 38, 40 are formed as round bolt clearance holes or elongated slots through the bracket body 16 between the handlebar mounting face 18 and the opposite face 22 where the ball mount 32 is secured. In order to facilitate both engaging a round or otherwise curved bar, such as a handlebar, and clearing a pre-existing instrument mounted on the handlebar, the bolt clearance apertures 38, 40 are provided in positions symmetrically straddling the handlebar groove 30 and are oriented crosswise of both a longitudinal axis of the elongated bracket body 16 and the bore of the handlebar groove 30.

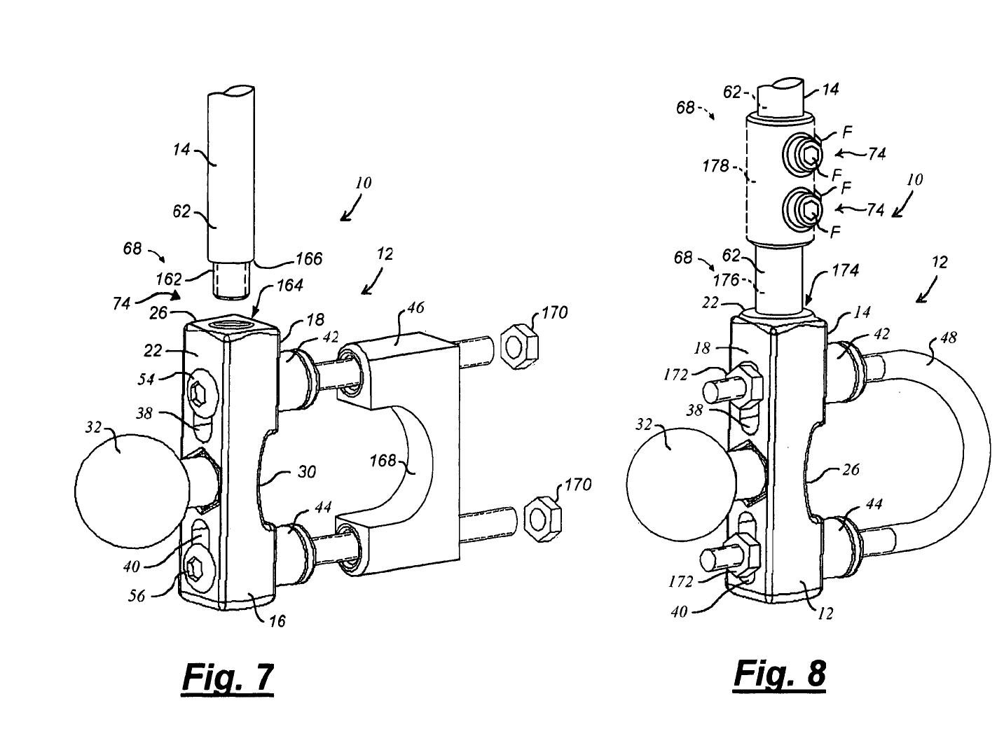

According to one embodiment of the invention, a pair of spacers 42, 44 are provided, one for each of the two bolt clearance apertures 38, 40. The spacers 42, 44 are long enough to hold the bracket body 16 away from the handlebar when another instrument or device is pre-existing on the handlebar, or to operate between the bracket body 16 and a U-clamp 46 (shown in FIG. 7) or with a U-bolt 48 (shown in FIG. 8) for securing the handlebar-mounting bracket apparatus 10 against slipping and shifting. The spacers 42, 44 are small enough in cross-section to avoid interference both with pre-existing instruments or devices on the vehicle handlebar and straddled by the handlebar groove 30, and pre-existing objects surrounding the bracket apparatus 10. By example and without limitation, the spacers 42, 44 are each embodied as a short, thick-walled cylinder structured with a respective bolt clearance hole 50, 52 formed longitudinally therethrough. The spacers 42, 44 are optionally formed either integral with or separate from the bracket body 16. When formed as discrete parts separate from the bracket body 16, the spacers 42, 44 are optionally formed of a vibration damping material such as a soft rubber or a synthetic elastomeric material such as a low-durometer silicone or polyurethane material.

A pair of threaded fasteners 54, 56 are used to secure the bracket body 16 of the mounting arm apparatus 10 to the vehicle handlebar. For example, the threaded fasteners 54, 56 are pre-existing mounting screws or bolts used to secure a pre-existing instrument or device on the vehicle handlebar, where the pre-existing instrument or device has a low profile in the vicinity of the mounting fasteners 54, 56. For example, the bolt clearance apertures 38, 40 are sized to straddle the pre-existing instrument or device while permitting the threaded fasteners 54, 56 to align with mounting holes in the pre-existing instrument or device. Alternatively, the threaded fasteners 54, 56 may be longer screws or bolts sized to replace shorter pre-existing mounting screws or bolts such that the replacement threaded fasteners 54, 56 secure the bracket body 16 of the mounting arm apparatus 10 to the vehicle handlebar while simultaneously securing the pre-existing instrument or device.

The permanently bendable support arm 14 is of the type disclosed in co-pending U.S. patent application Ser. No. 10/698,158 entitled, “FLEXIBLE SUPPORT ARM,” filed in the name of Jeffrey D. Carnevali on Oct. 31, 2003, and co-pending parent U.S. patent application Ser. No. 10/802,408 entitled, “CONFIGURABLE MOUNTING BRACKET,” filed in the name of Jeffrey D. Camevali on Mar. 17, 2004, the complete disclosures of which are all incorporated herein by reference. Accordingly, the permanently bendable support arm 14 is embodied, by example and without limitation, as an elongated solid rod formed of permanently bendable aluminum or aluminum alloy with a substantially constant diameter of about ½ inch, but at least in the range of about ⅛ inch, ¼ inch or ⅜ inch to about 1 inch. The solid rod of the support arm 14 is alternatively realized in steel, copper, permanently bendable copper alloys or another permanently bendable metal or rigid plastic material without limiting the practice of the invention. The support arm 14 is not limited to rods having round cross-sections; rather, the support arm 14 is alternatively realized in a solid rod having a square, rectangular, hexagonal, octagonal or other alternative cross-section.

By example and without limitation, the permanently bendable support arm 14 is illustrated as having different contiguous and interconnected bent and substantially straight portions 58, 60, respectively, permanently formed along its elongated length.

A first short and substantially straight lengthwise end portion 62 of the support arm 14 is secured by the multiply configurable mounting bracket 12, and a mounting platform 64 is mounted a second short and substantially straight lengthwise end portion 66 of the arm 14 opposite from the mounting bracket 12 securing the first end portion 62. The mounting platform 60 is embodied as any of a large variety of different mounting mechanisms, as discussed in detail herein.

A coupling means 68 is provided between the first end portion 62 of the support arm 14 and the mounting bracket 12. According to one embodiment of the invention, coupling means 68 is embodied having a collar 70 formed with a longitudinal cavity 72 that is sized to admit the first end portion 62 of the support arm 14 a short distance thereinto, and gripping means 74 for gripping the arm end portion 62. For example, the gripping means 74 is a threaded gripping means embodied as a clamp joint formed of one or more threaded fasteners F or set screws applied to an internally threaded aperture (as indicated at 74). According to the embodiment of the invention illustrated in FIG. 1, the collar 70 having the gripping means 74 formed therein is formed integrally with the mounting bracket body 16, as by molding, casting or machining.

In FIG. 2 the support arm 14 is mated directly to the bracket body 16. Accordingly, the longitudinal cavity 72 that is sized to admit the first end portion 62 of the support arm 14 is formed directly in the elongated mounting bracket 16 through the end face 26. The gripping means 74 is provided by one or more threaded fasteners F or set screws operating through internally threaded apertures (as indicated at F) that are formed directly in one or more of the side walls 18, 20, 22, 24 of the mounting bracket body 16.

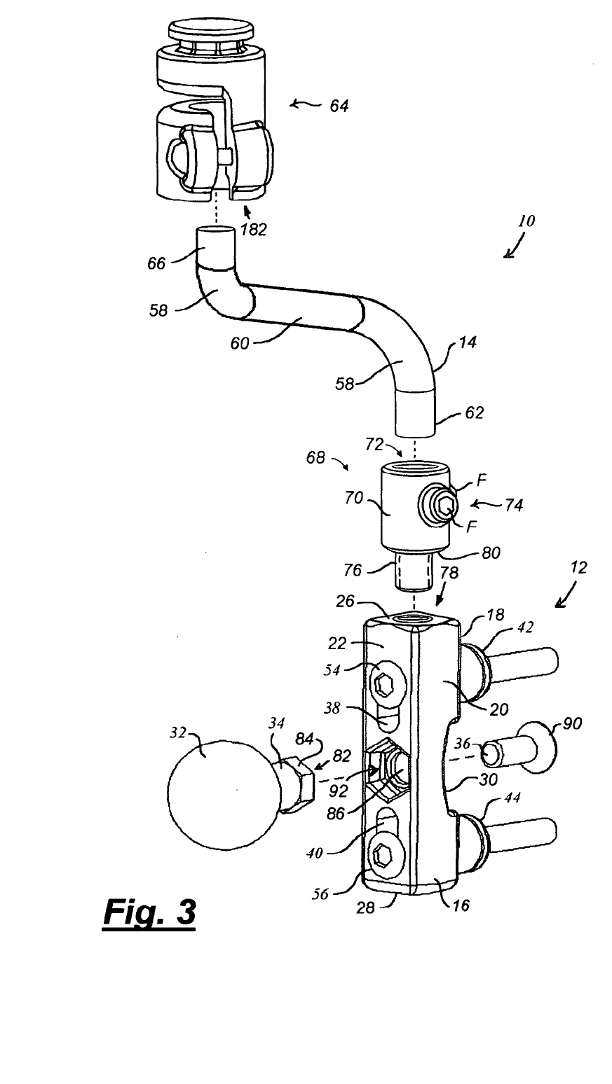

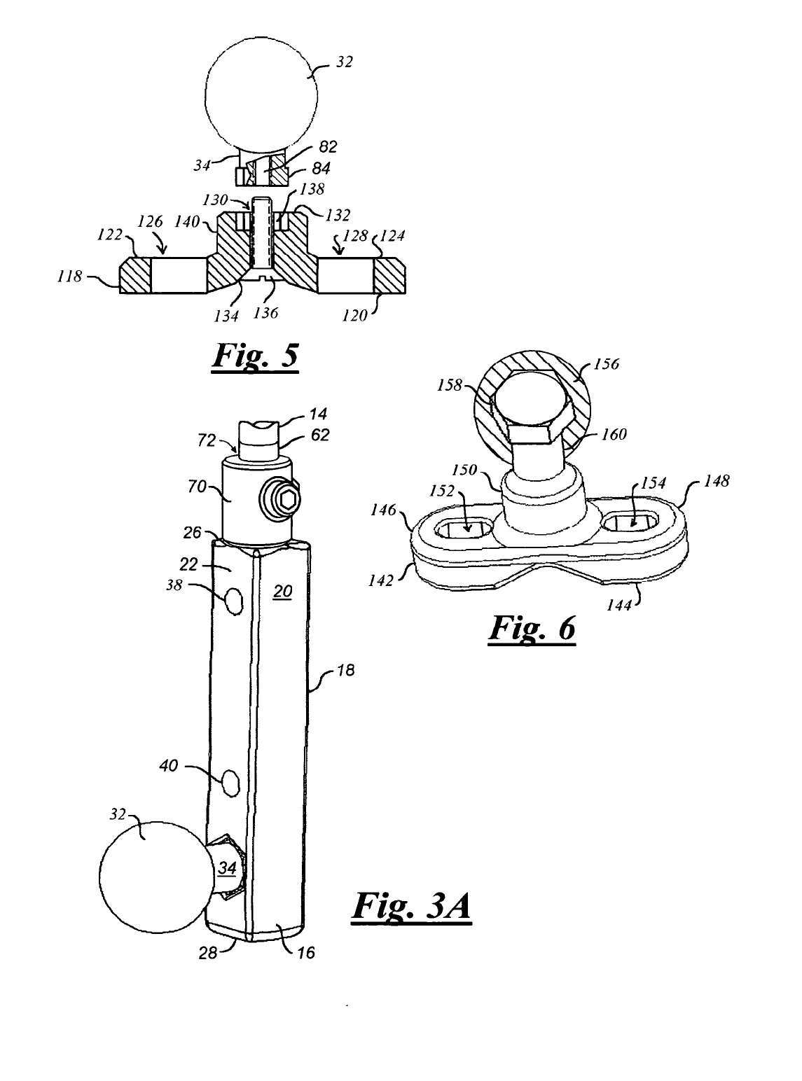

FIG. 3 is a partially exploded front pictorial view that illustrates assembly of the handlebar accessory mounting arm apparatus 10 of the invention. According to the exemplary embodiment illustrated in FIG. 3, the collar 70 having the gripping means 74 formed therein is a discrete part that is separate from both the support arm 14 and the mounting bracket body 16. Accordingly, the discrete collar 70 is a threaded union adapter that is structured for coupling the end portion 62 of the permanently bendable support arm 14 to the mounting bracket body 16. The discrete collar 70 includes the longitudinal cavity 72 that is sized to admit the first end portion 62 of the support arm 14 a short distance thereinto, and the gripping means 74 for gripping the arm end portion 62, both discussed herein. Furthermore, the discrete collar 70 is provided with a threaded male stud 76 sized to mate with a female thread 78 formed in one end face 26 of the elongated mounting bracket body 16. A shoulder 80 formed on the union adapter 70 surrounding the stud 76 provides a stop that operates against the bracket body end face 26. Mechanical means, such as a suitable lock washer, may be provided between the shoulder 80 and the bracket body end face 26 to resist relative rotation between the union adapter 70 and the bracket body 16. Alternatively, a commercially available chemical thread-locking product is provided between the male and female threads 76, 78.

As illustrated herein, the ball mount 32 is a discrete non-integral part-spherical ball mount that is provided on the second stem 34. The stem 34 is provided with an internally threaded longitudinal bore 82 structured to accept the threaded fastener 36 which is, for example, a conventional flat head screw. The stem 34 also includes means for fixing the ball mount 32 against rotation relative to the bracket body 16 during assembly of the threaded fastener 36 and in later use. By example and without limitation, the means for fixing the ball mount 32 against rotation is embodied in a hex-shaped lip 84 provided adjacent to the threaded bore 82.

As further illustrated in FIG. 3, a screw clearance hole 86 is formed through the bracket body 16 substantially at the center of the handlebar groove 30 and is oriented crosswise of both the elongated bracket body 16 and the bore of the handlebar groove 30, i.e., crosswise of the face 18 of the bracket body 16 having the handlebar groove 30 formed therein. The screw clearance hole 86 is structured with a first internal screw-head clearance relief 88 (shown in FIG. 2) formed substantially concentric with the clearance hole 86 within the handlebar groove 30. The screw-head clearance relief 88 is structured such that a flat head portion 90 of the screw 36 is flush or below the internal arcuate surface of the handlebar groove 30 so that it does not interfere with mounting the apparatus 10 onto a vehicle handlebar. The internal screw-head clearance relief 88 is formed as a conventional conical countersink when the screw 36 is a conventional flat head screw, or as a cylindrical counter-bore when the screw 36 is a pan, round, fillister, oval, hex, socket head or other conventional screw head. Mechanical means, such as a suitable lock washer, may be provided between the screw head 90 and the seat of the internal screw-head clearance relief 88 to resist relative rotation between the screw 36 and the bracket body 16. Alternatively, a commercially available chemical thread-locking product is provided between the male threads of the screw 36 and female threads of the threaded bore 82.

The bracket body 16 is structured with means for rotationally fixing the stem 34 of the discrete ball mount 32 relative to the face 22 from which it is projected. By example and without limitation, the lip portion 84 of the stem 34 is structured to occupy an outer female stem-capture relief 92 formed in the elongated bracket body 16 opposite from the handlebar groove 30 in a manner that resists rotation relative to the elongated body. The means for rotationally fixing the stem 34 is thus embodied by the outer female stem-capture relief 92 formed substantially concentric with the screw clearance hole 86 within the side surface or face 22 of the elongated bracket body 16 opposite from the handlebar groove 30, i.e., the face 22 of the bracket body 16 opposite from the face 18 having the handlebar groove 30 formed therein. The outer stem-capture relief 92 is formed with means for resisting rotation of the internally threaded stem 34 when secured therein by the threaded fastener 36 operating through the clearance hole 86. The means for resisting rotation of the stem 34 is provided by the outer female stem-capture relief 92 embodied as a cooperating hexagonal female relief when the stem 34 is embodied in the hex-shaped lip 84 adjacent to the threaded bore 82. Alternatively, the means for resisting rotation of the stem 34 is provided by the outer female stem-capture relief 92 embodied as a cooperating square female relief when the stem 34 is embodied in a square-shaped lip 84. The stem 34 and outer stem-capture relief 92 may alternatively be structured as cooperating male and female star shapes, or other cooperating male and female shapes. According to one embodiment of the invention, the cooperating male and female shapes of the stem lip 84 and outer stem-capture relief 92 are a cylindrical male stem lip 84 and cooperating cylindrical female counter-bore 92 with a knurled or otherwise suitably roughened seating surface in the floor thereof. According to yet another embodiment of the invention, a suitable lock washer is provided between the lip 84 of the male stem 34 and the floor of the female counter-bore 92 for resisting rotation of the stem 34 relative to the female stem-capture relief 92 and the face 22 of the elongated bracket body 16.

FIG. 3A illustrates configurable mounting bracket 12 according to another embodiment of the invention having the apertures 38, 40 embodied as round bolt clearance holes and the elongated bracket body 16 being sufficiently long to permit the ball mount 32 to be mounted outside the pattern of the apertures 38, 40, rather than having the apertures 38, 40 straddling the ball mount 32, as in other embodiments. Furthermore, the embodiment of FIG. 3A illustrates the elongated bracket body 16 being structured without the optional arcuate handlebar cutout or groove 30 being formed at or near the middle of one side or “handlebar mounting face” 18 thereof.

FIG. 4 illustrates one alternative embodiment of the invention wherein another discrete non-integral part-spherical ball mount 96 is optionally substituted for the part-spherical ball mount 32. The discrete non-integral part-spherical ball mount 96 is structured with a male threaded shaft 98 extended from a stem 100 upon which the resiliently deformable material of the part-spherical ball mount 96 is cast or over-molded, as described in co-pending U.S. patent application Ser. No. 10/862,688, the complete disclosure of which is incorporated herein by reference. The male threaded shaft 98 is threadedly engaged with a cooperating female thread 102 formed within a boss portion 104 of a discrete frame 106. The frame 106 is formed with a substantially flat mounting surface 108 for mounting to the substantially flat side face 22 of the bracket body 16. A pair of shoulders 110, 112 symmetrically straddle the threaded boss 108, the shoulders 110, 112 being formed with symmetrical apertures 114, 116 formed as round bolt clearance holes or elongated slots that are positioned to match the pair of bolt clearance apertures 38, 40 provided in the bracket body 16. The pair of threaded fasteners 54, 56 are passed through the symmetrical bolt clearance apertures 114, 116 and 38, 40 to simultaneously secure both the discrete ball mount 96 and the elongated bracket body 16 of the apparatus 10 to the vehicle handlebar, as described herein. Accordingly, the screw clearance hole 86 through the bracket body 16 with the screw-head clearance relief 88 and the outer female stem-capture relief 92 may be eliminated along with the threaded fastener or screw 36 through the bracket body 16, as discussed herein.

FIG. 4 also illustrates another alternative embodiment of the invention having the support arm 14 mated directly to the bracket body 16. Accordingly, the coupling means 68 between the first end portion 62 of the support arm 14 and the mounting bracket 12 is embodied by a conventional solder, braze, weld or other fusion joint 120, whereby the first end portion 62 of the support arm 14 is securely and permanently coupled to the end face 26 of the mounting bracket 12. The fusion coupling means 68 optionally includes the longitudinal cavity 72 formed directly in the elongated mounting bracket 16 through the end face 26. The longitudinal cavity 72 is sized to admit the first end portion 62 of the support arm 14 part way into the elongated mounting bracket 16, the longitudinal cavity 72 thereby stabilizes the support arm 14 relative to the mounting bracket 16 both during manufacturing and later in service.

The alternative ball mount 96 illustrated in FIG. 4 is just one of several possible embodiments of flanged ball mounts disclosed by Carnevali in co-pending U.S. patent application Ser. No. 10/862,688, the complete disclosure of which is incorporated herein by reference. Such other alternative embodiments are equivalents of the illustrated embodiment and are incorporated herein by reference.

FIG. 5 illustrates one alternative embodiment of the flanged ball mount having the discrete ball mount 32 mounted to a discrete frame 118. A screw clearance hole 130 is formed through the frame 118 between a substantially flat mounting surface 120 and a ball mount mounting surface 132 formed opposite from the frame's mounting surface 120 and includes a screw-head clearance relief 134 structured for clearance of a flathead screw or another suitable fastener 136. The threaded fastener or screw 136 is passed through the clearance hole 130 and threadedly engaged to the threaded internal longitudinal bore 82 of the discrete ball mount 32 for securing it to the frame 118. The frame 118 includes an outer female stem-capture relief 138 similar to the stem-capture relief 92 formed in the elongated bracket body 16, whereby the lip portion 84 of the ball mount stem 34 is engaged to restrict rotation relative to the frame 118 and, in turn, relative to the bracket body 16. The frame 118 is optionally formed with a boss 140 situated symmetrically between shoulders 122, 124 and apertures 126, 128 formed as round bolt clearance holes or elongated slots. When the frame 118 is formed with boss 140, the female stem-capture relief 138 is formed therein with the ball mount mounting surface 132 formed at the end thereof.

FIG. 6 illustrates yet another alternative embodiment of the flanged ball mount formed on a different discrete frame 142. The discrete frame 142 is formed with a substantially flat mounting surface 144 for mounting to the substantially flat side face 22 of the bracket body 16, and a pair of shoulders 146, 148 symmetrically straddle a stem 150. The shoulders 146, 148 are provided with symmetrical apertures 152, 154 formed as round bolt clearance holes or elongated slots that are positioned to match the pair of bolt clearance apertures 38, 40 provided in the bracket body 16. The pair of threaded fasteners 54, 56 are similarly passed through the symmetrical bolt clearance apertures 152, 154 and 38, 40 to simultaneously secure both the discrete frame 142 and the bracket body 16 of the apparatus 10 to the vehicle handlebar, as described herein. Accordingly, the screw clearance hole 86 in the bracket body 16 with the screw-head clearance relief 88 and the outer female stem-capture relief 92 may be eliminated along with the threaded fastener 36, as discussed herein.

An alternative discrete non-integral ball mount 156 is formed on the stem 150 which may include retaining means 158 for retaining the cast or over-molded resiliently deformable material forming the alternative discrete ball mount 156. By example and without limitation, the retaining means 158 is provided by a button head for retaining the cast or over-molded resiliently deformable material. The button head retaining means 158, shown by example and without limitation as having a hexagonal shape, is coupled to a necked-down shaft portion 160 of the stem 150.

FIG. 7 illustrates another alternative embodiment of the invention wherein the support arm 14 is mated directly to the bracket body 16. Accordingly, the gripping means 74 for gripping the arm end portion 62 is embodied by a threaded male stud 162 formed on the arm end portion 62 that is sized to mate with a longitudinal female thread 164 formed in one end face 26 of the elongated mounting bracket body 16. A shoulder 166 formed on the arm end portion 62 surrounds the stud 162 and provides a stop that operates against the bracket body end face 26. Mechanical means, such as a suitable lock washer, may be provided between the shoulder 166 and the bracket body end face 26 to resist relative rotation between the support arm 14 and the bracket body 16. Alternatively, a commercially available chemical thread-locking product is provided between the male and female threads 162, 164.

FIG. 7 also illustrates the bracket body 16 embodied for being secured to the vehicle handlebar directly, rather than securing the bracket body 16 through a pre-existing instrument or device, as described herein. Accordingly, the bracket body 16 is positioned on the front of the vehicle handlebar with the handlebar groove 30 fitted against a front surface of the vehicle handlebar. The threaded fasteners 54, 56 are passed through the symmetrical slots 38, 40 and extended on opposite sides of the vehicle handlebar. The U-clamp 46 is fitted over the threaded fasteners 54, 56 with a saddle portion 168 being fitted against a back surface of the vehicle handlebar opposite from the bracket body 16 of the apparatus 10. A pair of nuts 170 are threaded onto the respective threaded fasteners 54, 56 to secure the apparatus 10 to the vehicle handlebar with the ball mount 32 or the alternative ball mount 96 positioned as desired on the vehicle handlebar. FIG. 8 illustrates another alternative embodiment of the invention wherein the bracket body 16 is secured to the vehicle handlebar directly using the threaded U-bolt 48 and a pair of nuts 172 in place of the threaded fasteners 54, 56, U-clamp 46 and nuts 170 shown in FIG. 7.

FIG. 8 also illustrates another alternative embodiment of the invention wherein the support arm 14 is formed integrally with the bracket body 16, e.g., molded, cast, or machined, such that the support arm 14 is coupled directly to the bracket body 16. Accordingly, the coupling means 68 between the first end portion 62 of the support arm 14 and the mounting bracket 12 is a machined joint 174. Alternatively, only a short stump or stub 176 is formed integrally with the bracket body 16 and a union adapter 178 (shown in phantom) provides the coupling means 68 between the stub 176 and the end portion 62 of the support arm 14. By example and without limitation, the union adapter 178 includes the gripping means 74 embodied as one or more threaded fasteners F or set screws operating through internally threaded apertures (as indicated at F) for gripping the first end portion 62 of the support arm 14. The union adapter 178 further includes another set of the gripping means 74 also embodied as one or more threaded fasteners F or set screws operating through internally threaded apertures (as indicated at F) for gripping the integral stub 176 projected from the end face 26 of the mounting bracket 12.

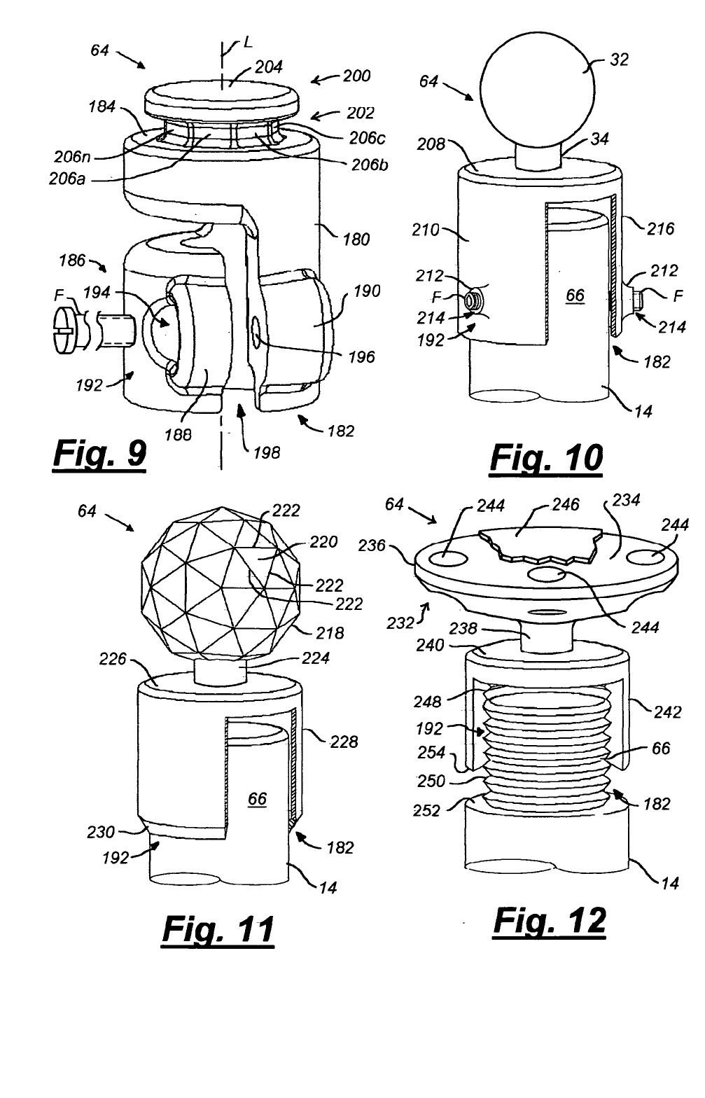

FIG. 9 is a detailed view of the mounting platform 64 shown in FIG. 1, which is mounted a second lengthwise end portion 66 of the support arm 14 opposite from the mounting bracket 12. According to the embodiment of FIG. 9, the mounting platform 64 is a cylindrical female collar 180 forming therein a truncated internal cylindrical cavity 182 with a closed base 184. The truncated cylindrical cavity 182 is sized to slip over the second short lengthwise end portion 66 of the support arm 14, as illustrated in FIG. 3. The cylindrical female collar 180 is split substantially parallel with its longitudinal axis L, whereby a longitudinal opening 198 is formed. A threaded side closure 186 is provided by a pair of bosses 188, 190 operating as a coupling means 192. One boss 188 is pierced with a fastener clearance aperture 194, while the other boss 190 is provided with an internally threaded aperture 196 that is substantially aligned with the fastener clearance aperture 194. A threaded fastener F operating between the fastener clearance aperture 194 and the internally threaded aperture 196 closes the longitudinal opening 198 by drawing together the bosses 188, 190 of the threaded side closure 186, which tightens the cylindrical cavity 182 about the second short lengthwise end portion 66 of the support arm 14 and thereby operates as the coupling means 192.

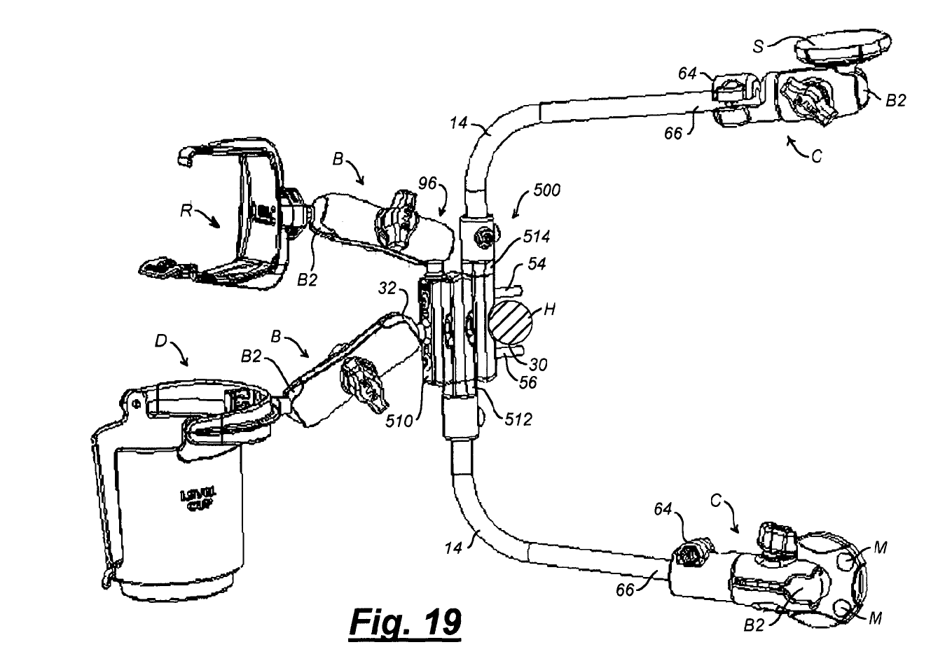

According to one embodiment of the invention, the collar 180 is topped by a positively-positionable wheel-and-axle mounting platform 200 that is shaped like a mushroom, including a multisided stem or axle portion 202 and with a disc-shaped button or wheel portion 204 mounted at one end. The positively-positionable wheel-and-axle mounting platform 200 is of the type disclosed by Carnevali in U.S. Pat. No. 6,561,476, “POSITIVELY-POSITIONABLE MOUNTING APPARATUS,” which is incorporated herein by reference. Accordingly, the axle portion 202 projects from the outer surface of the closed base 184 opposite from the truncated cylindrical cavity 182 formed in the cylindrical female collar 180. The mounting base 184 and the positively-positionable wheel-and-axle mounting platform 200 projecting from it are formed integrally with the collar 180 of a relatively rigid material, such as a metal or hard plastic. Alternatively, some or all of the collar 180, the axle portion 202, and the wheel portion 204 are formed as discrete units and joined together at a later manufacturing stage. According to one embodiment of the invention, the axle portion 202 is formed with a convex polygon shape, having multiple flat or planar surfaces 206a, 206b, 206c through 206n. The axle portion 202 is grasped by a pair of arm members of a coupler C (shown in FIG. 19) by obtaining a suitable grip between the wheel portion 204 and the outer surface of the closed base 184 of the collar 180. The disc-shaped wheel portion 204 is sufficiently thick to support at least a minimum predetermined load applied to the coupler C.

FIG. 10 illustrates one alternative embodiment of the mounting platform 64 having the part-spherical ball mount 32 formed on the stem 34 projected from a closed base 208 of an alternative tubular female collar 210 forming therein the truncated internal cylindrical cavity 182 which bottoms against the base 208. As discussed herein, the truncated cylindrical cavity 182 is sized to slip over the second short lengthwise end portion 66 of the support arm 14. The coupling means 192 is provide by one or more of the threaded fasteners For set screws operating through one or more bosses 212 at one or more positions spaced around the periphery of the tubular female collar 210. Respective internally threaded apertures 214 pierce the one or more bosses 212 and the adjacent of a side wall 216 of the tubular female collar 210. When the side wall 216 is sufficiently thick, the bosses 212 are optionally eliminated, and the threaded apertures 214 pierce the side wall 216 directly. One or more of the threaded fasteners F operating through the internally threaded apertures 214 engage the second short lengthwise end portion 66 of the support arm 14 and thereby operates as the coupling means 192.

FIG. 11 illustrates the mounting platform 64 according to another embodiment of the invention having a partial geodesic sphere 218 of the type disclosed by Carnevali in U.S. Pat. No. 6,581,892, entitled “GEODESIC MOUNTING APPARATUS,” issued Jun. 24, 2003, which is incorporated herein by reference. The partial geodesic sphere 218 is a part spherical body having a surface that is formed with a plurality of discrete substantially planar, triangularly-shaped facets 220 intersecting at angular joints 222. Each triangular facet 220 is formed as a substantially planar surface oriented perpendicularly to a radius from a spherical center point of part-spherical geodesic sphere 218. Each triangular facet 220 is one segment of the 3-dimensional geodesic sphere 218. Geodesic sphere 218 is embodied in any number of multifaceted 3-dimensional forms. The partial geodesic sphere 218 is formed on a stem 224 projected from a closed base 226 of an alternative tubular female collar 228 forming therein the truncated internal cylindrical cavity 182 which is sized to slip over the second short lengthwise end portion 66 of the support arm 14 and bottoms against the base 226. The coupling means 192 is provided by a weld or other fusion joint 230 formed at least intermittently between the end portion 66 of the support arm 14 and the tubular female collar 228.

FIG. 12 illustrates the mounting platform 64 according to yet another embodiment of the invention having a flanged mounting platform 232 of the type disclosed by Carnevali in co-pending U.S. patent application Ser. No. ______ (Attorney Docket No. NPI-025) entitled, “CONFIGURABLE MOUNTING APPARATUS,” filed in the name of Jeffrey D. Carnevali on Jun. 30, 2004, the complete disclosure of which is incorporated herein by reference. Accordingly, the flanged mounting platform 232 is formed with a substantially planar mounting surface 234 opposite from the main body of the support arm 14. According to one or more embodiments of the invention, the flanged mounting platform 232 is provided with a peripheral flange 236 formed on a stem 238 projected from a closed base 240 of an alternative tubular female collar 242 having formed therein the truncated internal cylindrical cavity 182 which is sized to slip over the second short lengthwise end portion 66 of the support arm 14 and bottoms against the base 240. The flange 236 is optionally structured with multiple apertures 244 that operate as mounting holes for securing an external device using a mechanical fastener operated through one or more of the multiple apertures 244. The multiple apertures 244 are thus embodied as clearance holes for mounting screws (not shown) used to secure an external device, such as a cradle, to the flanged mounting platform 232. The apertures 244 are optionally formed with countersinks or counter-bores to accommodate the heads of the mounting screws. According to other embodiments of the invention, the substantially planar mounting surface 234 is an adhesively bondable surface for adhesively bonding an external device to be attached thereto. Alternatively, the mounting surface 234 is supplied with a bi-adhesive tape or resilient adhesive pad 246, commonly known as a Pressure Sensitive Adhesive or PSA, applied between substantially the entire mounting surface 234 and the external device to be attached thereto.

The coupling means 192 is provided by internal threads 248 provided within the 10 truncated cylindrical cavity 182 and structured to match external threads 250 provided on the second short lengthwise end portion 66 of the support arm 14. The matching internal and external threads 248, 250 cooperate to provide a threaded joint that operates as the coupling means 192 between the end portion 66 of the support arm 14 and the tubular female collar 242 of the mounting platform 64. The end portion 66 of the support arm 14 is oversized relative to the threads 250 such that a shoulder 252 is provided on the surface of the end portion 66. The shoulder 252 operates as a stop against which a lip 254 opening into the cylindrical cavity 182 of the tubular female collar 242 is seated when the internal threads 248 and external threads 250 are fully engaged.

Multiple handlebar accessory mounting arm apparatus 10 of the invention are 20 optionally combined or “stacked” into different handlebar accessory mounting arm systems. The systems illustrated are not all inclusive and are not intended to be illustrate all the possible systems into which the handlebar accessory mounting arm apparatus 10 of the invention may be combined. Rather, the exemplary systems included herein illustrate the ability to combine multiple of the handlebar accessory mounting arm apparatus 10 into many different systems.

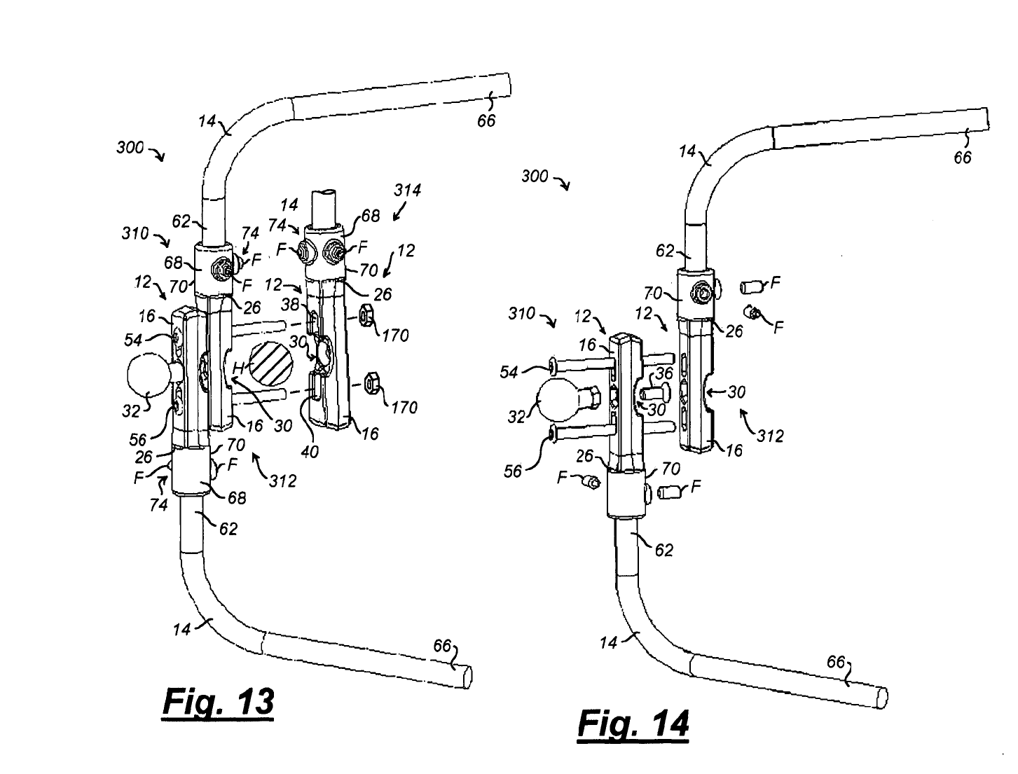

FIG. 13 illustrates one handlebar accessory mounting arm system 300 that combines a pair of the handlebar accessory mounting arm apparatus 10 of the invention, a first assembly 310 being formed of a first of the rigid multiply configurable mounting brackets 12 having a first permanently bendable support arm 14 mated to the end face 26 of one bracket body 16 using, by example and without limitation, the union adapter 70 with the gripping means 74 is provided by one or more of the threaded fasteners F. It will be readily understood that the support arm 14 is alternatively coupled to the bracket body 16 using any of the coupling means 68 disclosed herein or any equivalent thereof. A second assembly 312 is formed of a second of the rigid multiply configurable mounting brackets 12 is combined with the first such bracket 12, the second bracket 12 having a second permanently bendable support arm 14 mated to the end face 26 of its bracket body 16 also using, by example and without limitation, the union adapter 70 with the gripping means 74 is provided by one or more of the threaded fasteners F. Again, it will be understood that the support arm 14 is alternatively coupled to the bracket body 16 using any of the coupling means 68 disclosed herein or any equivalent thereof.

By example and without limitation, the bracket 12 of the first assembly 310 optionally includes one of the discrete non-integral part-spherical ball mount 32 of the type described herein. When present, the ball mount 32 is arranged crosswise of the bracket body 16 and is secured thereto using, by example and without limitation, the threaded fastener or screw 36 through the bracket body 16, as discussed in detail herein. It will be readily understood that the ball mount 32 is configured according to any of the embodiments illustrated herein and equivalents thereof, and further, that the ball mount 32 is alternatively coupled to the bracket body 16 using according to any of the embodiments disclosed herein and equivalents thereof.

The mounting brackets 12 of the two assemblies 310, 312 are illustrated as being assembled or “stacked” with each respective arcuate handlebar groove 30 facing in a same direction for mounting on one side of the handlebar H (shown in cross-section) using, by example and without limitation, the threaded fasteners 54, 56, as discussed herein. It will be readily understood that the stacked assembly system 300 is alternatively coupled to the handlebar H according to any of the embodiments disclosed herein and equivalents thereof.

The bracket 12 of the second combination assembly 312 is optionally mounted on the handlebar H oppositely of the first bracket 12, as indicated, with the bracket body 16 turned with its arcuate handlebar groove 30 facing toward the opposite side of the handlebar H from the bracket 12 of the first assembly 310. The two threaded fasteners 54, 56 are extended past the handlebar H and through the slots bolt clearance apertures 38, 40, and the pair of nuts 170 are threaded onto the respective threaded fasteners 54, 56 to secure the two assemblies 310, 312 of the combination assembly 300 to the vehicle handlebar H with the ball mount 32 positioned as desired on the vehicle handlebar H. Alternatively, the bracket 12 arranged on the opposite side of the handlebar H with the oppositely facing handlebar groove 30 is a third combination assembly 314 of the invention provided in combination with the first and second assemblies 310, 312.

FIG. 14 is an exploded assembly view of the handlebar accessory mounting arm system 300 illustrated in FIG. 13 wherein like numerals indicate like elements disclosed in FIG. 13 and elsewhere herein.

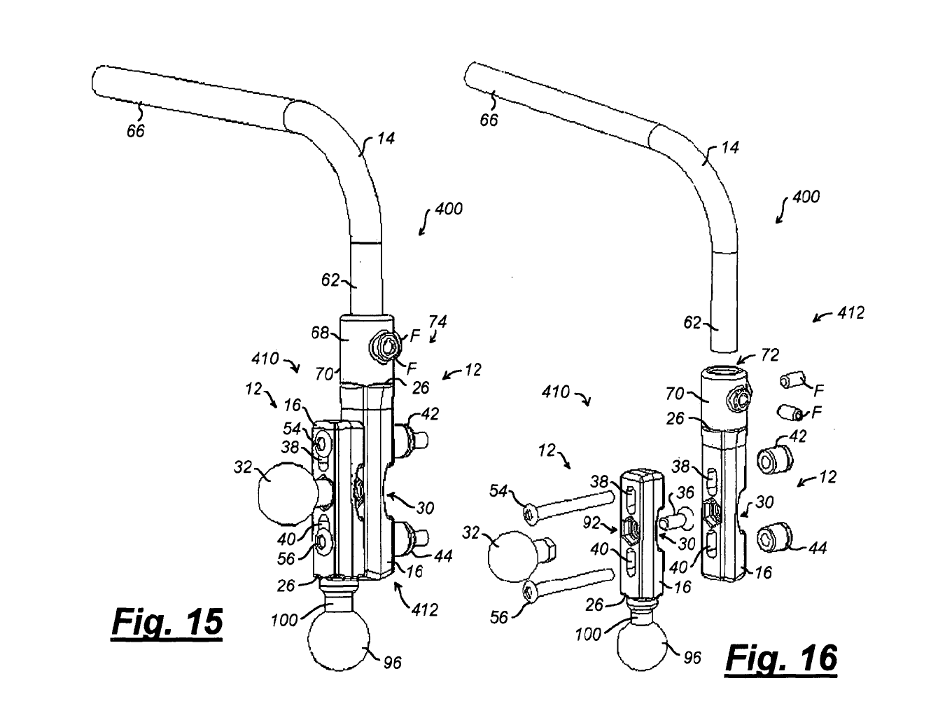

FIG. 15 illustrates another handlebar accessory mounting arm system 400 that combines a pair of the handlebar accessory mounting arm apparatus 10 of the invention, a first assembly 410 being formed of a first of the rigid multiply configurable mounting brackets 12 having one of the discrete non-integral part-spherical ball mount 96 of the type described herein mated to the end face 26 of one bracket body 16 using, by example and without limitation, the male threaded shaft 98 of the stem 100 upon which the resiliently deformable material of the part-spherical ball mount 96 is cast or over-molded. The threaded shaft 98 is mated with the longitudinal female thread 164 formed in one end face 26 of the elongated mounting bracket body 16, as discussed herein. Alternatively, the stem 100 upon which the resiliently deformable material of the part-spherical ball mount 96 is cast or over-molded is formed integrally with the bracket body 16, as disclosed by Carnevali in co-pending U.S. patent application Ser. No. 10/862,688, “CONFIGURABLE MOUNTING BRACKET,” which is incorporated herein by reference.

By example and without limitation, the bracket 12 of the first assembly 410 optionally includes one of the discrete non-integral part-spherical ball mount 32 of the type described herein. When present, the ball mount 32 is arranged crosswise of the bracket body 16 and is secured thereto using, by example and without limitation, the threaded fastener or screw 36 through the bracket body 16, as discussed in detail herein. It will be readily understood that the ball mount 32 is configured according to any of the embodiments illustrated herein and equivalents thereof, and further, that the ball mount 32 is alternatively coupled to the bracket body 16 using according to any of the embodiments disclosed herein and equivalents thereof.

A second assembly 412 is formed of a second of the rigid multiply configurable mounting brackets 12 and combined with the first such bracket 12, the second bracket 12 having one of the permanently bendable support arms 14 disclosed herein mated to the end face 26 of its bracket body 16. The threaded fasteners 54, 56 passed through the bolt clearance apertures 38, 40 operate to combine the two assemblies 410, 412 into the handlebar accessory mounting arm system 400. A pair of the spacers 42, 44 may be provided to hold the bracket body 16 away from the handlebar when another instrument or device is pre-existing on the handlebar, or to operate between the bracket body 16 and a U-clamp 46 (shown in FIG. 7) or with a U-bolt 48 (shown in FIG. 8) for securing the handlebar accessory mounting arm system 400 against slipping and shifting.

FIG. 16 is an exploded assembly view of the handlebar accessory mounting arm system 400 illustrated in FIG. 15 wherein like numerals indicate like elements disclosed in FIG. 15 and elsewhere herein.

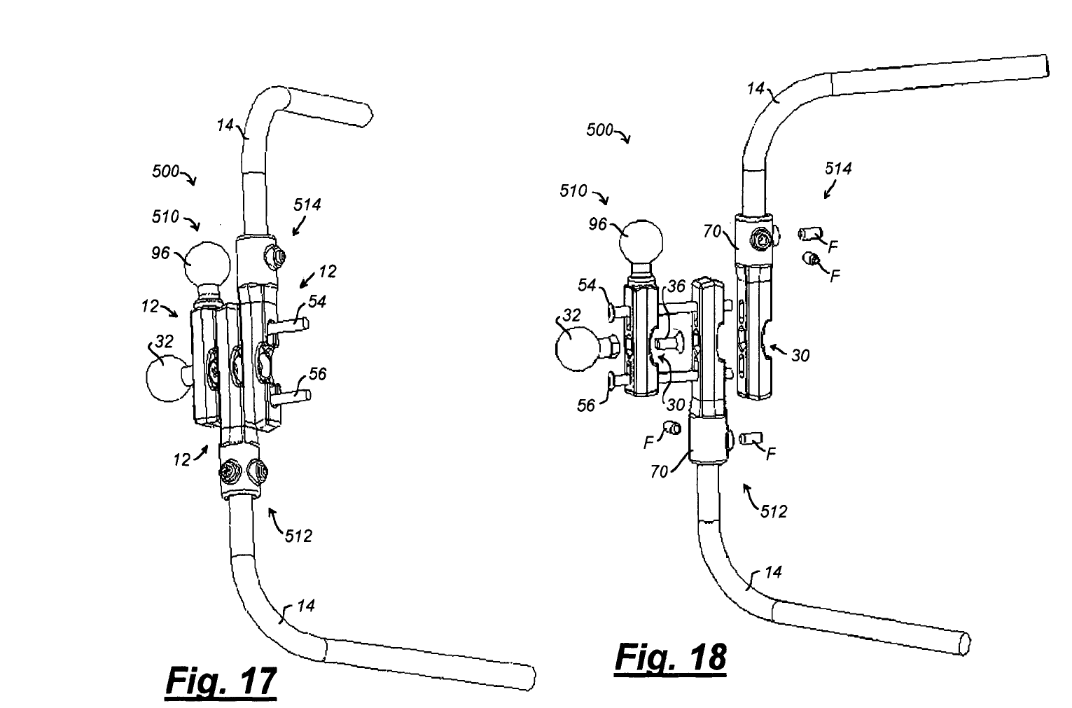

FIG. 17 illustrates another handlebar accessory mounting arm system 500 that is a combination of the two different assemblies 300 and 400 illustrated in FIGS. 13 and 15, respectively. Accordingly, the system 500 combines a trio of the handlebar accessory mounting arm apparatus 10 of the invention, a first assembly 510 is formed of a first of the rigid multiply configurable mounting brackets 12 having one of the discrete non-integral part-spherical ball mount 96 of the type described herein mated to the end face 26 of one bracket body 16 using, by example and without limitation, the male threaded shaft 98 of the stem 100 upon which the resiliently deformable material of the part-spherical ball mount 96 is cast or over-molded. The threaded shaft 98 is mated with the longitudinal female thread 164 formed in one end face 26 of the elongated mounting bracket body 16, as discussed herein. Alternatively, the stem 100 upon which the resiliently deformable material of the part-spherical ball mount 96 is cast or over-molded is formed integrally with the bracket body 16, as disclosed by Camevali in co-pending U.S. patent application Ser. No. 10/862,688, “CONFIGURABLE MOUNTING BRACKET,” which is incorporated herein by reference.

By example and without limitation, the bracket 12 of the first assembly 510 optionally includes one of the discrete non-integral part-spherical ball mount 32 of the type described herein. When present, the ball mount 32 is arranged crosswise of the bracket body 16 and is secured thereto using, by example and without limitation, the threaded fastener or screw 36 through the bracket body 16, as discussed in detail herein. It will be readily understood that the ball mount 32 is configured according to any of the embodiments illustrated herein and equivalents thereof, and further, that the ball mount 32 is alternatively coupled to the bracket body 16 using according to any of the embodiments disclosed herein and equivalents thereof.

A second assembly 512 is formed of a second of the rigid multiply configurable mounting brackets 12 and combined with the first such bracket 12, the second bracket 12 having one of the permanently bendable support arms 14 disclosed herein mated to the end face 26 of its bracket body 16. A third assembly 514 is formed of a third of the rigid multiply configurable mounting brackets 12 and combined with the first and second such brackets 12, the third bracket 12 having another one of the permanently bendable support arms 14 disclosed herein mated to the end face 26 of its bracket body 16. The second and third assemblies 512, 514 are optionally relatively inverted (shown) such that the two support arms 14 are presented in opposite directions.

The threaded fasteners 54, 56 passed through the bolt clearance apertures 38, 40 operate to combine the three assemblies 510, 512, 514 into the triple handlebar accessory mounting arm system 500. A pair of the spacers 42, 44 may be provided to hold the bracket body 16 away from the handlebar when another instrument or device is pre-existing on the handlebar, or to operate between the bracket body 16 and a U-clamp 46 (shown in FIG. 7) or with a U-bolt 48 (shown in FIG. 8) for securing the triple handlebar accessory mounting arm system 500 against slipping and shifting.

FIG. 18 is an exploded assembly view of the handlebar accessory mounting arm system 500 illustrated in FIG. 17 wherein like numerals indicate like elements disclosed in FIG. 17 and elsewhere herein.

FIG. 19 illustrates the triple handlebar accessory mounting arm system 500 of FIG. 17 with the threaded fasteners 54, 56 securing the three assemblies 510, 512, 514 in the single system 500 and further securing the system 500 to the handlebar H. having one of the mounting platforms 64 mounted the second lengthwise end portion 66 of each permanently bendable support arm 14 opposite from the respective mounting bracket 12. Each of the mounting platforms 64 is, by example and without limitation, positively-positionable wheel-and-axle mounting platform 200 of the type disclosed by Carnevali in U.S. Pat. No. 6,561,476, which is incorporated herein by reference, and is grasped by a pair of arm members of a coupler C of the type disclosed by Camevali in U.S. Pat. No. 6,561,476 for use with the wheel-and-axle mounting platform 200. The couplers C are useful for operation with a second resiliently compressible ball mount B2 positioned at a second end thereof and clamped rigidly between within the respective coupler C Each of the second ball mounts B2 is fitted with a useful device, such as a flat mounting surface S (shown at top) that may include one or more mounting holes M formed therethrough for coupling a useful device or instrument to the mounting surface S. It will be readily understood that the mounting platforms 64 is configured according to any of the embodiments illustrated herein and equivalents thereof.

Each of the ball mounts 32, 96 are, by example and without limitation, grasped by a bifurcated coupler B of the type disclosed by Carnevali in U.S. Pat. No. 5,845,885, entitled “UNIVERSALLY POSITIONABLE MOUNTING DEVICE,” issued to Jeffrey D. Carnevali on Dec. 8, 1998, the complete disclosure of which is incorporated herein by reference. The bifurcated coupler B are useful for operation with one of the second resiliently compressible ball mounts B2 positioned at a second end thereof and clamped rigidly between within the respective bifurcated coupler B. Each of the second ball mounts B2 is fitted with a useful device, such as a drink holder D or a cradle R of a type structured for releasably holding a cellular phone or other useful instrument.

While the preferred embodiment of the invention has been illustrated and described, it will be appreciated that various changes can be made therein without departing from the spirit and scope of the invention. For example, materials may be substituted for the different components of the apparatus of the invention without departing from the spirit and scope of the invention. Furthermore, as at least one embodiment of the invention is provided wherein the bracket is mounted using pre-existing bolt or screws 54, 56 that secure a pre-existing instrument or other device, the apparatus 10 of the invention is not limited to mounting on a vehicle handlebar but is structured for mounting in any position on any ground, marine or airborne vehicle having a pre-existing instrument or device with a suitably arranged mounting bolt pattern wherein a pair of pre-existing mounting bolts is matched by the bolt clearance apertures 38, 40 through the bracket body 16. Therefore, the inventor makes the following claims.

1. A mounting arm apparatus, comprising:
a mounting bracket formed of a substantially rigid elongated body having a pair of apertures formed through the body; and
a permanently bendable support arm having a first end portion that is fixedly coupled to one end of the elongated body of the mounting bracket.

2. The apparatus of claim 1, further comprising a groove formed in one longitudinal surface of the rigid elongated body with a longitudinal axis of the groove oriented crosswise of the elongated body.

3. The apparatus of claim 1, further comprising a part-spherical ball mount coupled to the body and oriented substantially crosswise to a longitudinal axis thereof, the part-spherical ball mount being formed of a resiliently deformable material.

4. The apparatus of claim 3 wherein the part-spherical ball mount further comprises a discrete part-spherical ball mount that is threadedly coupled to the body.

5. The apparatus of claim 1 wherein the first end portion of the support arm is threadedly secured to the body.

6. The apparatus of claim 1, further comprising a plurality of the mounting brackets, at least one of the plurality of mounting brackets having the permanently bendable support arm coupled to one end of the elongated mounting bracket body.

7. The apparatus of claim 6, further comprising a second permanently bendable support arm having a first end portion that is fixedly coupled to one end of the elongated mounting bracket body of a second one of the mounting brackets.

8. The apparatus of claim 7, further comprising a part-spherical ball mount coupled to the body of one of the first and second elongated mounting brackets in a position between the apertures and oriented substantially crosswise to a longitudinal axis of the body, the part-spherical ball mount being formed of a resiliently deformable material.

9. The apparatus of claim 6, further comprising a part-spherical ball mount coupled to one end of the elongated body of a second one of the plurality of mounting brackets and oriented substantially in alignment with a longitudinal axis of the elongated body, the part-spherical ball mount being formed of a resiliently deformable material.

10. A mounting arm apparatus, comprising:
a mounting bracket formed of a substantially rigid elongated body formed therethrough with a pair of fastener clearance passages oriented crosswise of a longitudinal axis of the elongated body; and
a permanently bendable solid metal support arm having first and second end portions at opposite ends thereof, the first end portion being fixedly coupled to one end of the elongated body of the mounting bracket and oriented substantially in alignment with the longitudinal axis of the body.

11. The apparatus of claim 10 wherein the support arm further comprises a discrete support arm, and
further comprising means for coupling the first end portion of the discrete support arm to the body.

12. The apparatus of claim 11 wherein the means for coupling the first end portion of the discrete support arm to the body further comprises a coupling means selected from the group of coupling means consisting of: a threaded joint, a fusion joint and clamp joint.

13. The apparatus of claim 10, further comprising a discrete part-spherical ball mount coupled to the elongated body between the pair of fastener clearance passages and oriented substantially crosswise to the longitudinal axis of the rigid elongated body, the part-spherical ball mount being formed of a resiliently deformable material with a substantially smooth outer surface.

14. The apparatus of claim 10, further comprising a plurality of the mounting bracket, at least a first one of the plurality of mounting brackets having the first end portion of the permanently bendable solid metal support arm fixedly coupled to one end of the elongated body thereof.

15. The apparatus of claim 14, further comprising a second permanently bendable solid metal support arm having a first end portion thereof fixedly coupled to one end of the elongated body of a second one of the plurality of mounting brackets.

16. The apparatus of claim 15, further comprising a discrete part-spherical ball mount coupled to the elongated body of one of the plurality of mounting brackets between the pair of fastener clearance passages and oriented substantially crosswise to the longitudinal axis of the rigid elongated body, the part-spherical ball mount being formed of a resiliently deformable material with a substantially smooth outer surface.

17. The apparatus of claim 16 wherein the mounting bracket having the ball mount coupled to the elongated body thereof further comprises one of the first and second mounting brackets having the respective first and second support arms fixedly coupled to one end of the elongated body thereof.

18. The apparatus of claim 16 wherein the mounting bracket having the ball mount coupled to the elongated body thereof further comprises a third mounting bracket that is different from the first and second mounting brackets.

19. The apparatus of claim 18, further comprising a part-spherical ball mount coupled to one end of the elongated body of the third mounting bracket and oriented substantially in alignment with a longitudinal axis of the elongated body, the part-spherical ball mount being formed of a resiliently deformable material with a substantially smooth outer surface.

20. The apparatus of claim 19 wherein the third mounting bracket further comprises a stud projected from one end of the elongated body thereof, the stud being formed integrally with the elongated body and the resiliently deformable material of the part-spherical ball mount being formed over the integral stud.

21. A mounting arm apparatus, comprising:
a substantially rigid elongated mounting bracket formed of:
a substantially rectangular body formed with substantially orthogonal side faces arranged in alignment with a longitudinal axis of the body, and opposing end faces oriented substantially orthogonal to the side faces and the longitudinal axis of the body, and
a pair of fastener clearance passages formed through the body and oriented substantially crosswise of the longitudinal axis of the elongated body; and
a permanently bendable elongated metal rod having first and second substantially straight lengthwise end portions at opposite ends thereof, the first end portion being substantially aligned with the longitudinal axis of the body and fixedly coupled to one of the opposing end faces thereof.

22. The apparatus of claim 21, further comprising a groove formed partway through the body between the pair of fastener clearance passages and having a longitudinal axis oriented substantially crosswise of the longitudinal axis of the elongated body with an opening in a first side face of the body.

23. The apparatus of claim 22 wherein the groove further comprises an arcuate groove.

24. The apparatus of claim 21, further comprising a first part-spherical ball mount projected from a second side face of the body and being oriented substantially crosswise to the longitudinal axis of the body, the second part-spherical ball mount being formed of a resiliently deformable material having a substantially smooth outer surface.

25. The apparatus of claim 22 wherein the threaded joint between the second side face of the elongated body and the first part-spherical ball mount further comprises:
a fastener clearance passage formed through the body between the arcuate groove and the second side face of the elongated body,
a rigid stem having the resiliently deformable material of the first part-spherical ball mount molded on a first end thereof and a female thread formed in a second end opposite from the resiliently deformable material, and
a threaded fastener in the fastener clearance passage, the threaded fastener being threadedly coupled to the female thread formed in the stem of the first part-spherical ball mount.

26. The apparatus of claim 24, further comprising a threaded joint between the second side face of the elongated body and the first part-spherical ball mount projected therefrom.

27. The apparatus of claim 26 wherein the threaded joint between the second side face of the elongated body and the first part-spherical ball mount further comprises a frame member interposed between the resiliently deformable material of the first part-spherical ball mount and the elongated body, the frame comprising a pair of fastener clearance passages formed therethrough symmetrically straddling the resiliently deformable material of the first part-spherical ball mount and being substantially aligned with the pair of fastener clearance passages formed through the body.

28. The apparatus of claim 21 wherein the permanently bendable metal rod further comprises a metal rod that is discrete from the bracket, and
further comprising coupling means for fixedly coupling the first end portion of the discrete metal rod to the end face of the bracket body.

29. The apparatus of claim 28 wherein the coupling means further comprises one of: fusing, threading, and clamping the first end portion of the discrete metal rod to the end face of the bracket body.

30. The apparatus of claim 21, further comprising a plurality of the mounting brackets, at least one of the plurality of mounting brackets having the permanently bendable metal rod coupled to one of the opposing end faces of the elongated mounting bracket body.

31. The apparatus of claim 30, further comprising a second permanently bendable elongated metal rod having first and second substantially straight lengthwise end portions at opposite ends thereof, the first end portion of the second metal rod being substantially aligned with the longitudinal axis of a body of a second one of the plurality of mounting brackets and being fixedly coupled to one of the opposing end faces thereof.

32. The apparatus of claim 31, further comprising a first part-spherical ball mount projected from a side face of the body of one of the plurality of mounting brackets between the pair of fastener clearance passages and being oriented substantially crosswise to the longitudinal axis of the body, the second part-spherical ball mount being formed of a resiliently deformable material having a substantially smooth outer surface.

33. The apparatus of claim 32 wherein the one of the plurality of mounting brackets having the ball mount projected from the second side face of the elongated body thereof further comprises one of the first and second mounting brackets having respective first and second metal rod fixedly coupled to one of the opposing end faces thereof.

34. The apparatus of claim 30 wherein the one of the plurality of mounting brackets having the ball mount projected from the second side face of the elongated body thereof further comprises a third mounting bracket that is different from each of the first and second mounting brackets.

35. The apparatus of claim 34, further comprising a second part-spherical ball mount projected from one end face of the elongated body of the third mounting bracket and aligned substantially along a longitudinal axis of the body, the second part-spherical ball mount being formed of a resiliently deformable material having a substantially smooth outer surface.

36. The apparatus of claim 35 wherein the second part-spherical ball mount further comprises a stem integrally formed with the elongated body of the third mounting bracket and projected from the end face thereof, and the resiliently deformable material being coupled to an end portion of the stem distal from the end face of the body.

37. The apparatus of claim 35 wherein the second part-spherical ball mount further comprises a stem that is threadedly engaged with the end face of the elongated body of the third mounting bracket and projected therefrom, and the resiliently deformable material being coupled to an end portion of the stem distal from the end face of the body.
